(19) United States
(12) Patent Application Publication
(10) Pub. No.: US 2002/0088692 A1
(43) Pub. Date: Jul. 11, 2002

(54) Snap tech with Z-Tech Fit # SMS-BA1 in line breakaway device used on overhead conveyors where shackles are attached by hooks, bracket, etc.

(76) Inventors: Jeffrey Allen Harden, Dothan, AL (US); Kathleen Harden, Dothan, AL (US)

Correspondence Address: Jeffrey Allen Harden, 129 Stillwood Road, Dothan, AL, 36303, US

(21) Appl. No.: 09/757,233

(22) Filed: Jan. 9, 2001

(51) Int. Cl. B65G 17/20

(52) U.S. Cl. 198/678.1

(57) ABSTRACT

The Snap Tech With Z-Tech Fit SMS-BA1 new technical disclosures are the sleeve With the expansion Groove incorporated with the Z-angle of cut which allows the spring like effect during the initial penetration of the two angles ( Z-Fit Angles ) and then allows The expansion sleeve to SNAP back together and hold the desired torque until the device Is required to disengage. We machine all of our angles and sleeve to tolerances of 1/10^{th} of one thousandth of 1 inch to ensure consistent disengagement on each Snap Tech with Z-Tech Fit #SMS-BA1 that is installed. This ensures each customer that the product will be safe and will dis-engage at the required torque preventing equipment damage and down time and lost production. This device is completely re-usable. It is the only one of its kind in the market place today that we know of.

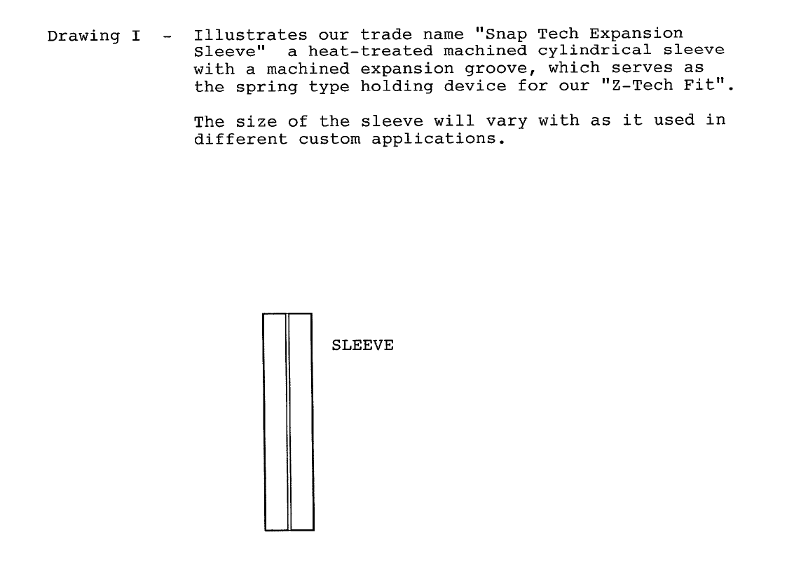

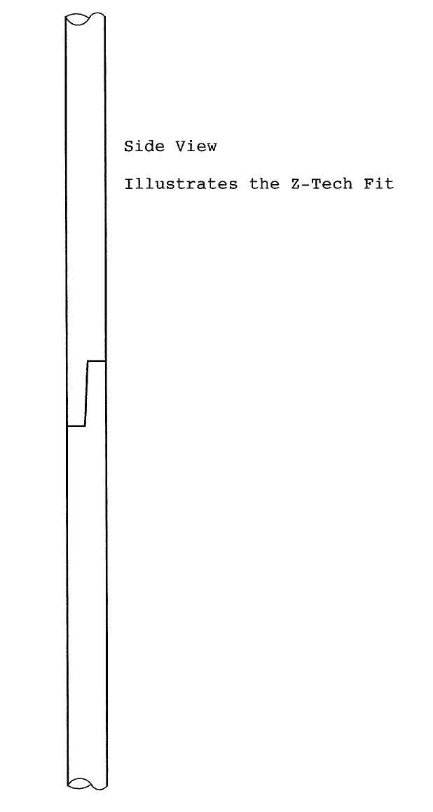

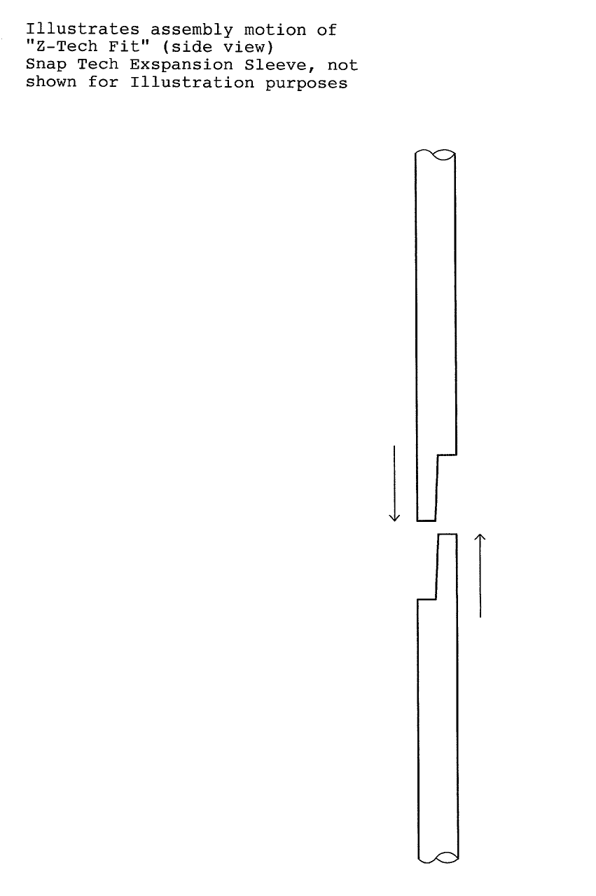

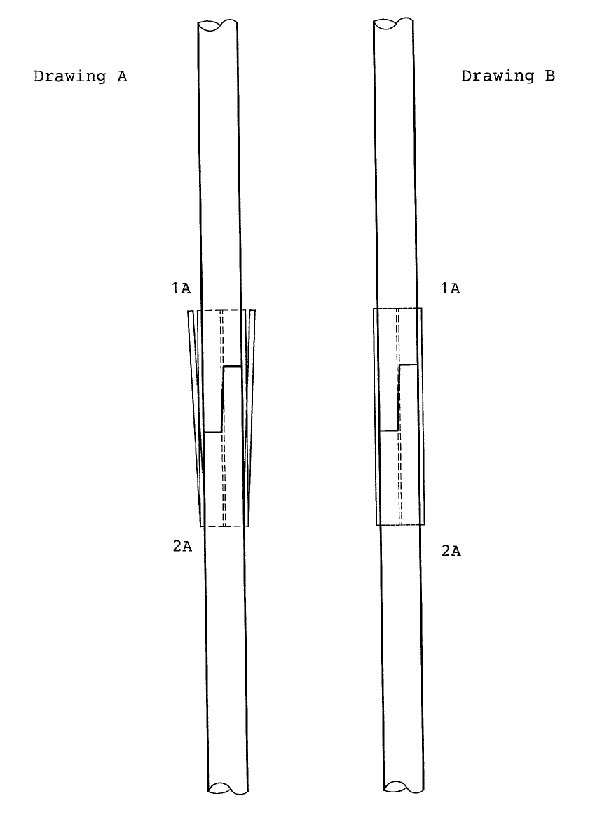

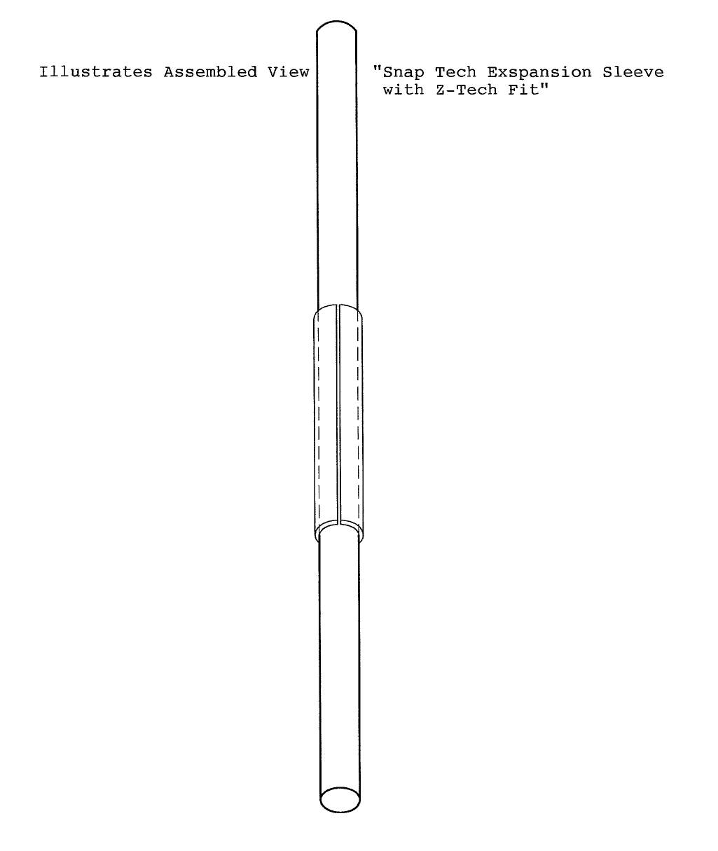

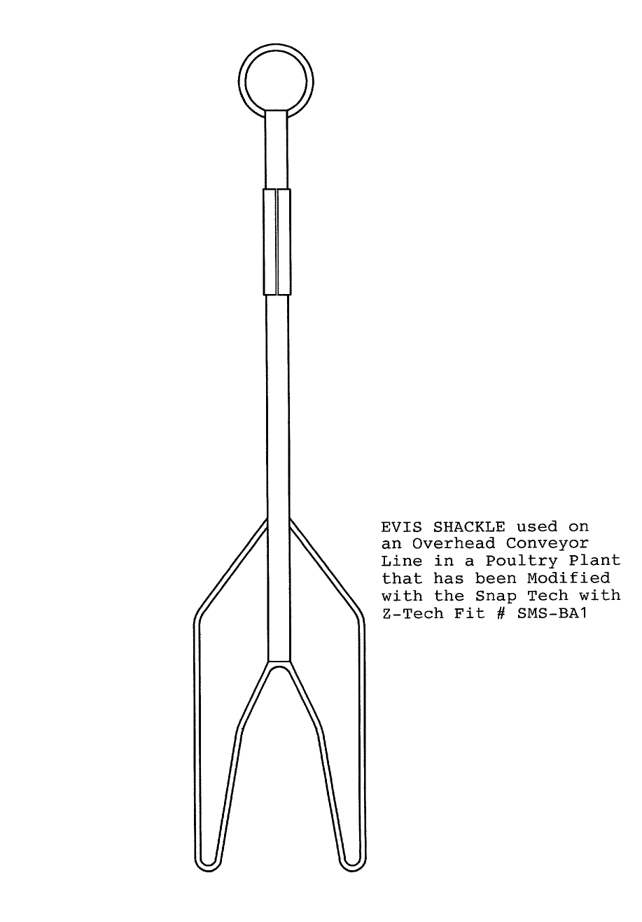

### CROSS-REFERENCE TO RELATED APPLICATIONS Not Applicable

### STATEMENT REGARDING FEDERALLY SPONSORED RESEARCH OR DEVELOPMENT Not Applicable

### REFERENCE TO MICROFICHE APPENDIX NOT APPLICABLE

### BACKGROUND OF THE INVENTION

Industries desires a solution to the problem of hang-ups on their Overhead Conveyor Systems, causing down time and damage to product and or equipment and injuries to their employees, working near their Overhead Conveyor Systems.

Along with these criteria, for economic reasons, they desire such a device to be reusable, (not a throw away item). Also, desiring the device be In-Line and Non-Rotating. This information was discovered by intense fieldwork in Plants.

We have conducted extensive research on existing devices such as J-Hooks, Break-Away Clips and Shear Pins. After evaluation of these items and meeting with Management and Engineering in Industries, we found these types of items, currently used in the industry, fail to meet the Customers criteria.

We feel after months of research, development and design, we have a product which meets and exceeds all Industries concerns on the Overhead Conveyor breakaway devices.

### BRIEF SUMMARY OF THE INVENTION

To patent the concept (Idea) of an in-line Breakaway device used in Poultry, Beef or any other Industry where overhead Conveyor Lines with hooks, brackets, shackles, etc, may attach themselves, accidentally, to a person, equipment or other objects located near the Overhead Conveyor Line.

This device can vary in size to meet customer's needs. The device also varies in Z machine fit depending on the amount of torque needed to disengage the “Snap Tech SMS-BA1”.

### EXAMPLE

Chicken Hanging on a Poultry Shackle

Vs.

Beef Hanging on a Meat Hook

The Torque required to disengage the Poultry Shackle would be much less than the Meat Hook. This would change the Z Machine Angle to Create a different degree of torque for each shackle or hook for each different application.

The Size and Type of material used to manufacture the “Snap Tech SMS-BA1” would depend on Customers existing applications and needs.

### BRIEF DESCRIPTION OF THE SEVERAL VIEWS OF THE DRAWINGS

### Drawing I

Illustrates our trade name “ Snap Tech Expansion Sleeve” A heat-treated machined cylindrical sleeve with a machined expansion groove, which serves as the spring type holding device for our “Z-Tech Fit”

The size of the sleeve will vary with as it used in different custom applications. (Expansion Sleeve's can be ordered as replacement items to repair existing units already modified by Southern Mechanical & Structural Inc.)

### Drawing II

Illustrates our Trade name “Z-Tech Fit” (side view) Snap Tech Expansion Sleeve is not shown for illustration purposes.

### Drawing III

Illustrates assembly motion of “ Z-Tech Fit” (side view) Snap Tech Expansion Sleeve is not shown for illustration purposes.

### Drawing IV

Illustrates the Snap Tech Expansion Sleeve's actual function and has a part A and Part B illustration drawing. Part A. illustrates 2 parts 1A & 2A. Part 2A is the part the Snap Tech Expansion Sleeve is Spot Welded too.

Part 1A is the part that is the separate piece which inserts into Snap Tech Expansion Sleeve to form Z-Fit.

Drawing A illustrates the initial penetration of part IA and shows the function of the machined groove In the Snap Tech Expansion Sleeve.

Drawing part B illustrates a completely assembled fit after the Snap Tech Expansion Sleeve has returned from a forced sprung position to its Z-Fit holding position.

### Drawing V

Illustrates assembled view of “Snap Tech with Z-Tech Fit #SMS-BA1”.

### Drawing VI

Illustrates example of a Snap Tech with Z-Tech Fit #SMS-BA1's Expansion Sleeve used in an existing product. This is an Evis Shackle used on an overhead Conveyor Line in a Poultry Plant that has been modified.

### DETAILED DESCRIPTION OF THE INVENTION

Snap Tech with Z-Tech Fit # SMS-BA1

The modification of a new or existing product requiring a Breakaway feature for safety purposes or damage to equipment.

Mainly to be used for overhead conveyors, but not limited to such conveyors.

Item to be cut in two pieces.

Each end to be machined to Z-Fit Configuration, as custom applications require. This cannot be limited to size or angle of Z-Fit cut because of different product weights and different breakaway torque requirements. The design of the Z-Fit angles is based on the amount of torque required on each individual application. The greater the Z-Angle, the more torque is increased. The lesser the Z-Angle is machined less torque is required to disengage the Snap Tech with Z-Tech Fit #SMS-BA1's Expansion Sleeve.

The Snap Tech Expansion Sleeve is a heat-treated cylindrical sleeve with spring like properties with an expansion Groove machined vertically in the sleeve itself. This expansion groove is critical to the forgiveness of the spring action and holding capabilities of this sleeve.

The Snap Tech Expansion Sleeve is then located and spot-welded above the machined Z-Fit so it will encapsulate the Z-Fit area holding the assembly in place.

Once assembled and machined to the application's specification the Snap Tech with Z-Tech Fit #SMS-BA1 will disengage as required and solve the customer's problem.

This unit is installed in line and will be a working integral part of the existing product it is installed on so that the product will perform as if no modification had been performed until the Snap Tech with Z-Tech Fit #SMS-BA1 needs to function.

The inline integral design also solves the problem of un-wanted rotation of shackles or hooks; the rotation of shackles and hooks is a major problem in food processing industries.

1. What I claim my invention is a device used on an overhead conveyor or other
Types of conveyors and or Equipment, which would make them capable of Disengaging automatically when any part of conveyor or equipment becomes entangled Or attaches itself to a person or any stationary object located on or around above Mentioned Conveyors or Equipment.
This device can vary in size, material and angle of z-cut depending on the specific application the customer would require:
This device can be either modified to an existing piece of equipment or can Be implemented in the manufacturing process of a new piece of equipment.
Once the device has been dis-engaged you only have to simply line it up and SNAP it back into place.
The most important trait of this design is the Sleeve itself using the expansion Groove located in the sleeve to allow the Z-Cuts to SNAP into place by creating A forced spring action allowing the sleeve to expand during initial penetration Of the assembly procedure and then SNAPING back into place holding the two Parts firmly together until dis-engagement is required.
This device is an in-line device that will not change design of the original Piece of equipment after Snap Tech with Z-Tech Fit # SMS-BA1 is installed. And Because of this design each time this device is required to disengage it will Allows line up 100% straight with whatever obstacle that has forced it to engage Allowing no damage to occur to Snap Tech Expansion Sleeve or the Customers Equipment he is trying to protect.
This device will offer a solution to a problem in many industries where No workable solution existed with out sacrificing either safety or decrease in Production because of restraints forced upon the customer by such items as J-Hooks Or shear pin type products which slowed down production and did not work consistently which also lead to being un safe if a persons self or articles of jewelry Became attached to the modified piece of equipment and it did not engage properly.
The Snap Tech with Z-Tech Fit #SMS-BA1 disengagement will always be Consistent because each Z-Fit and Sleeve are made on computerized milling machine And lathes to tolerances within 1/10^{th} of one thousandth of 1 inch this assures each Snap Tech Sleeve will engage to the customers specification of required torque to Disengage properly.
